(19) United States
(12) Patent Application Publication
(10) Pub. No.: US 2023/0217392 A1
(43) Pub. Date: Jul. 6, 2023

(54) WIRELESS COMMUNICATION SYSTEM, BASE STATION DEVICE AND WIRELESS COMMUNICATION METHOD

(71) Applicant: NIPPON TELEGRAPH AND TELEPHONE CORPORATION, Tokyo (JP)

(72) Inventors: Keita KURIYAMA, Musashino-shi, Tokyo (JP); Hayato FUKUZONO, Musashino-shi, Tokyo (JP); Masafumi YOSHIOKA, Musashino-shi, Tokyo (JP); Takafumi HAYASHI, Musashino-shi, Tokyo (JP)

(73) Assignee: NIPPON TELEGRAPH AND TELEPHONE CORPORATION, Tokyo (JP)

(21) Appl. No.: 18/008,899

(22) PCT Filed: Jun. 12, 2020
(86) PCT No.: PCT/JP2020/023236

§ 371 Date: Dec. 7, 2022

(51) Int. Cl. H04W 56/00; H04L 5/14; H04J 3/00

(52) U.S. Cl. CPC H04W 56/004; H04L 5/14; H04J 3/00

(57) ABSTRACT

In a wireless communication system in which there is a propagation delay between a terminal station device and a base station device using time division multiplexing in a duplex operation system, at least one of the base station device or the terminal station device includes a delay calculating unit that calculates a propagation delay, and the base station device or the terminal station device includes a control unit that changes a frame configuration such that a standby time required for switching between the uplink frame and the downlink frame is shortened in accordance with the propagation delay. In accordance with this, a surplus standby time is shortened, and a transmission capacity can be improved.

### TECHNICAL FIELD

The present invention relates to a transmission capacity improvement technology used in a case in which there is a propagation delay between a base station device and a terminal station device in a wireless communication system in which the base station device and the terminal station device perform communication using time division multiplexing in a duplex operation system.

### BACKGROUND ART

In a wireless communication system using time division multiplexing (hereinafter, referred to as time division duplex (TDD)) in a duplex operation system, switching between a downlink signal (DL) from a base station device to a terminal station device and an uplink signal (UL) from the terminal station device to the base station device is necessary. At the time of switching between the DL and the UL, a guard time (a standby time) used for preventing a collision between signals is provided. Here, by providing a guard time longer than a propagation delay for a transmission distance between the DL and the UL, a collision between the DL and the UL can be avoided. For example, a method of determining a guard time in accordance with a predicted propagation delay may be considered (see NPL 1).

### CITATION LIST

### Non Patent Literature

[NPL 1] Fumiki UZAWA, Kazuhiko MITSUYAMA, and Tetsuomi IKEDA, “A study on TDD for bi-directional FPU”, ITE Annual Convention 2011, 13-10, 2011 (https://doi.org/10.11485/iteac.2011.0_13-10-1).

### SUMMARY OF THE INVENTION

### Technical Problem

In a case in which a predicted propagation delay for a transmission distance is long in a wireless communication system in which a base station device and a terminal station device perform communication using time division multiplexing in a duplex operation system, a guard time that is set becomes long as well. However, in a case in which a predicted propagation delay is longer than an actual propagation delay, a guard time for an actual propagation delay becomes excessively long, and a surplus standby time at the time of switching between a DL and a UL occurs, and there is a problem of reduction of a transmission capacity.

An object of the present invention is to provide a wireless communication system, abase station device, and a wireless communication method capable of improving a transmission capacity by shortening a surplus standby time by changing a frame configuration in a case in which a guard time for a propagation delay between a base station device and a terminal station device using time division multiplexing in a duplex operation system becomes excessively long.

### Means for Solving the Problem

According to the present invention, in a wireless communication system in which there is a propagation delay between a terminal station device and a base station device using time division multiplexing in a duplex operation system, at least one of the base station device or the terminal station device includes a delay calculating unit that calculates the propagation delay between the terminal station device and the base station device, and the base station device or the terminal station device includes a control unit that changes a frame configuration of at least one of an uplink frame or a downlink frame such that a standby time required for switching between the uplink frame from the terminal station device to the base station device and the downlink frame from the base station device to the terminal station device is shortened in accordance with the propagation delay calculated by the delay calculating unit.

In addition, according to the present invention, in a wireless communication system in which there is a propagation delay between a terminal station device and a base station device using time division multiplexing in a duplex operation system, at least one of the base station device or the terminal station device includes a detecting unit that detects no-signal sections of a signal communicated between the terminal station device and the base station device within a guard time, and the base station device or the terminal station device includes a control unit that changes a frame configuration of at least one of an uplink frame or a downlink frame such that a standby time required for switching between the uplink frame from the terminal station device to the base station device and the downlink frame from the base station device to the terminal station device is shortened in accordance with the no-signal sections detected by the detecting unit.

Furthermore, according to the present invention, in a base station device performing wireless communication with a terminal station device using time division multiplexing in a duplex operation system, the base station device may include: a delay calculating unit that calculates a propagation delay between the terminal station device and the base station device; and a control unit that changes a frame configuration of at least one of an uplink frame or a downlink frame such that a standby time required for switching between the uplink frame from the terminal station device to the base station device and the downlink frame from the base station device to the terminal station device is shortened in accordance with the propagation delay calculated by the delay calculating unit.

In addition, according to the present invention, in a base station device performing wireless communication with a terminal station device using time division multiplexing in a duplex operation system, the base station device may include: a detecting unit that detects no-signal sections of a signal communicated between the terminal station device and the base station device within a guard time, and a control unit that changes a frame configuration of at least one of an uplink frame or a downlink frame such that a standby time required for switching between the uplink frame from the terminal station device to the base station device and the downlink frame from the base station device to the terminal station device is shortened in accordance with the no-signal sections detected by the detecting unit.

Furthermore, according to the present invention, in a wireless communication method in which there is a propagation delay between a terminal station device and a base station device using time division multiplexing in a duplex operation system, the wireless communication method may include: performing a delay calculating process of calculating the propagation delay between the terminal station device and the base station device by using at least one of the base station device or the terminal station device, and performing a control process of changing a frame configuration of at least one of an uplink frame or a downlink frame such that a standby time required for switching between the uplink frame from the terminal station device to the base station device and the downlink frame from the base station device to the terminal station device is shortened in accordance with the propagation delay calculated in the delay calculating process by using the base station device or the terminal station device.

In addition, according to the present invention, in a wireless communication method in which there is a propagation delay between a terminal station device and a base station device using time division multiplexing in a duplex operation system, the wireless communication method may include: performing a detection process of detecting no-signal sections of a signal communicated between the terminal station device and the base station device within a guard time by using at least one of the base station device or the terminal station device; and performing a control process of changing a frame configuration of at least one of an uplink frame or a downlink frame such that a standby time required for switching between the uplink frame from the terminal station device to the base station device and the downlink frame from the base station device to the terminal station device is shortened in accordance with the no-signal sections detected in the detection process by using the base station device or the terminal station device.

### Effects of the Invention

In a wireless communication system, abase station device, and a wireless communication method according to the present invention, a transmission capacity is able to be improved by shortening a surplus standby time by changing a frame configuration in a case in which a guard time for a propagation delay between the base station device and the terminal station device using time division multiplexing in a duplex operation system becomes long.

### BRIEF DESCRIPTION OF DRAWINGS

FIG. 1 is a diagram illustrating a configuration example of a wireless communication system that is common to embodiments.

FIG. 2 is a diagram illustrating a comparative example of a case in which a frame configuration is not changed.

FIG. 3 is a diagram illustrating an example of change of frame configurations of a UL and a DL.

FIG. 4 is a diagram illustrating an example of change of a frame configuration dedicatedly used for the DL.

FIG. 5 is a diagram illustrating a configuration example of a base station device and a terminal station device according to a first embodiment.

FIG. 6 is a diagram illustrating an example of a processing sequence of a wireless communication system according to the first embodiment.

FIG. 7 is a diagram illustrating a configuration example of a base station device and a terminal station device according to a second embodiment.

FIG. 8 is a diagram illustrating an example of a processing sequence of a wireless communication system according to the second embodiment.

FIG. 9 is a diagram illustrating an example of a processing sequence of a wireless communication system according to a third embodiment.

FIG. 10 is a diagram illustrating a configuration example of a base station device and a terminal station device according to a fourth embodiment.

FIG. 11 is a diagram illustrating an example of a processing sequence of a wireless communication system according to the fourth embodiment.

### DESCRIPTION OF EMBODIMENTS

Hereinafter, a wireless communication system, a base station device, and a wireless communication method according to embodiments of the present invention will be described with reference to the drawings.

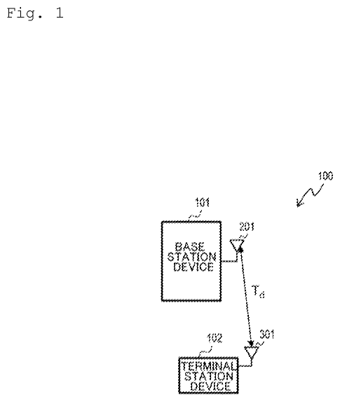

FIG. 1 is a diagram illustrating a configuration example of a wireless communication system 100 that is common to embodiments.

In FIG. 1, the wireless communication system 100 includes a base station device 101 and a terminal station device 102.

The base station device 101 includes an antenna 201 and performs wireless communication with an antenna 301 of the terminal station device 102. In the wireless communication system 100, TDD is used in a duplex operation system, a downlink (DL) signal and an uplink (UL) signal are multiplexed using time division.

In each of the embodiments to be described below, the embodiments are effective in both cases in which a predicted propagation delay between the base station device 101 and the terminal station device 102 is longer than an actual propagation delay and in which a guard time set for the predicted propagation delay becomes excessively long with respect to the actual propagation delay.

In FIG. 1, the base station device 101 performs wireless communication between the antenna 201 and the antenna 301 of the terminal station device 102, and a propagation delay at that time is T_{d}.

For example, in a case in which a distance between the base station device 101 and the terminal station device 102 is 9 km, a unidirectional propagation delay T_{d} between the base station device 101 and the terminal station device 102 is about 30 psec. In a case in which the base station device 101 and the terminal station device 102 communicate with each other using TDD, it is necessary to set a guard time (GT) in accordance with a propagation delay such that frames do not collide with each other at the time of switching between the UL and the DL. However, in a case in which a guard time set in advance by predicting a propagation delay between the base station device 101 and the terminal station device 102 becomes excessively long with respect to an actual propagation delay, a surplus standby time between a frame of a UL and a frame of a DL occurs, and there is a problem in that the transmission capacity decreases.

Thus, in a case in which a guard time set in advance becomes excessively long with respect to an actual propagation delay, the wireless communication system 100 described in each of the embodiments to be described below changes the frame configuration such that the transmission capacity is not decreased by shortening a surplus standby time. More specifically, a payload length is extended such that a surplus standby time is shortened in a range in which a collision between the UL and the DL does not occur.

### Example of Frame Configuration of Comparative Example

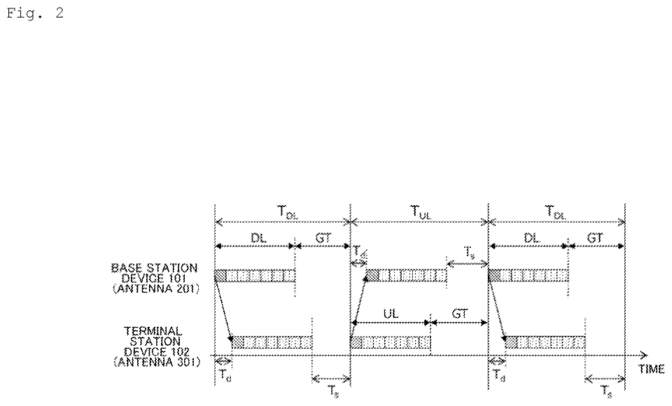

FIG. 2 is a diagram illustrating a comparative example of a case in which a frame configuration is not changed. In the comparative example, communication is performed without changing the frame configuration, and thus, in a case in which a guard time set in advance becomes excessively long with respect to an actual propagation delay, a surplus standby time occurs.

In FIG. 2, a base station device 101 communicates with a terminal station device 102 for a frame of a DL and a frame of a UL using TDD.

In the example illustrated in FIG. 2, each of the frame of the DL and the frame of the UL is composed of 7 subframes including a header, and a period T_{DL} of the DL including a GT and a period T_{UL} of the UL including a GT are the same and are alternately repeated.

In the period T_{DL}, a frame of a DL transmitted from an antenna 201 of the base station device 101 is received by an antenna 301 of the terminal station device 102, and a propagation delay at that time is T_{d}. On the other hand, in the period T_{UL}, a frame of a UL transmitted from the antenna 301 of the terminal station device 102 is received by the antenna 201 of the base station device 101, and a propagation delay at that time is T_{d}.

Here, in the example illustrated in FIG. 2, when an actual propagation delay T_{d} is shorter than a propagation delay predicted in advance, the GT becomes excessively longer than the actual propagation delay T_{d}, and a surplus standby time occurs. For example, in a case in which a predicted transmission distance is 50 km, the propagation delay is about 170 usec, and when the actual propagation delay T_{d} is 30 usec, the surplus standby time Tₛ is 140 usec. In addition, actually, a time acquired by excluding a minimum margin, which is necessary at the time of switching between the DL and the UL, from the standby time Tₛ becomes a surplus standby time.

In this way, in the comparative example illustrated in FIG. 2, when a guard time set in advance becomes excessively long with respect to an actual propagation delay, a surplus standby time occurs, and there is a problem in that the transmission capacity is decreased.

[Example of Frame Configuration Common to Each Embodiment]

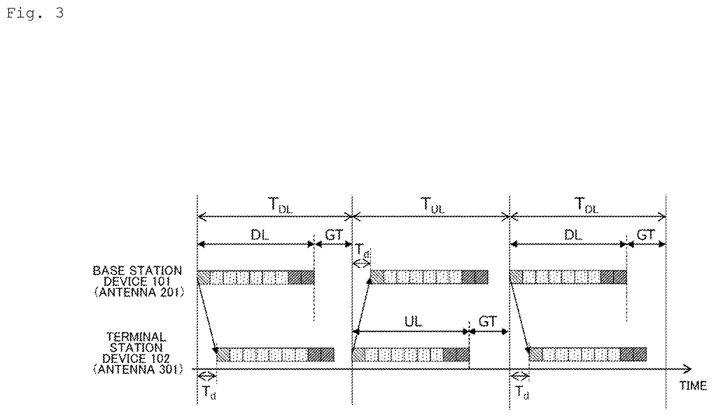

FIG. 3 is a diagram illustrating an example of change of frame configurations of a UL and a DL. Here, the example illustrated in FIG. 3 is a drawing similar to FIG. 2 of the comparative example and is an example of change of frame configurations common to each embodiment to be described below.

In FIG. 3, a base station device 101 communicates with a terminal station device 102 for a frame of a DL and a frame of a UL using TDD.

In the example illustrated in FIG. 3, in order to decrease the surplus standby time described in FIG. 2, a frame configuration of each of the DL from the base station device 101 to the terminal station device 102 and the UL from the terminal station device 102 to the base station device 101 is changed. In FIG. 3, a frame of each of the DL from the base station device 101 to the terminal station device 102 and the UL from the terminal station device 102 to the base station device 101 is extended from the frame illustrated in FIG. 2 (7 sub-frames) to 9 sub-frames. In addition, since communication data is stored in a sub-frame, extension of the sub-frame is equivalent to extension of a payload length, and thus a transmission capacity is improved.

Here, a period of the downlink including a GT (T_{DL}) and a period of the uplink including a GT (T_{UL}) are the same as those of the comparative example illustrated in FIG. 2 and are alternately repeated with a fixed period. In other words, although the period T_{DL} and the period T_{UL} are the same as those of the comparative example illustrated in FIG. 2, the payload length of a frame of each period is extended, and thus a transmission capacity in each of the period T_{DL} and the period T_{UL} is improved from that of the comparative example illustrated in FIG. 2.

In this way, in the example illustrated in FIG. 3, by shortening the GT of the terminal station device 102 and extending the payload lengths of frames of the DL and the UL, surplus standby times in the period T_{DL} and the period T_{UL} can be shortened. In accordance with this, the payload lengths are extended, and thus an effect of improvement of the transmission capacity can be acquired.

Here, the base station device 101 may change at least one of a modulation system and an encoding system to a system that is strong for data error in accordance with an increase in the transmission capacity according to extension of the payload lengths. In accordance with this, communication quality and reliability of the wireless communication system 100 are improved. A combination of a modulation system and an encoding system is given as a modulation and coding scheme (MCS) index. For example, when the MCS index becomes smaller, the transmission capacity becomes smaller, and the combination becomes stronger for data error. Thus, by decreasing the MCS index in correspondence with an increase in the transmission capacity according to extension of the payload lengths, the communication quality and the reliability can be improved without changing the transmission capacity.

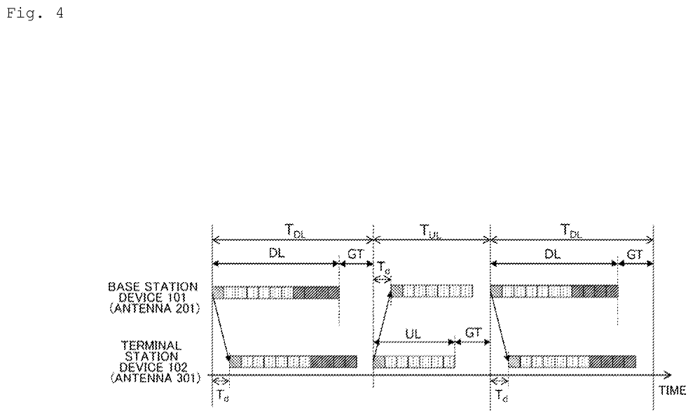

FIG. 4 illustrates an example of change of a frame configuration dedicatedly used for the DL. Here, similar to FIG. 3, the example illustrated in FIG. 4 is an example of change of a frame configuration common to the embodiments, and the base station device 101 and the terminal station device 102 perform communication using TDD. Although an example in which a frame configuration dedicatedly used for the DL is changed is illustrated in FIG. 4, a frame configuration dedicatedly used for the UL may be changed.

In the example illustrated in FIG. 4, although a frame configuration of UL2 from the terminal station device 102 to the base station device 101 is the same as that of the example illustrated in FIG. 2 and is not changed, only a frame configuration of DL2 from the base station device 101 to the terminal station device 102 is changed. In the example illustrated in FIG. 4, while the frame of the UL2 is composed of 7 sub-frames, the frame of the DL2 is extended to 11 sub-frames. As described with reference to FIG. 3, extension of sub-frames in which communication data is stored is equivalent to extension of a payload length and improves the transmission capacity.

Here, in the case of FIG. 3, although both the period T_{DL} of (DL+GT) and the period T_{UL} of (UL+GT) are periods of the same length, in the case of FIG. 4, the period T_{DL} of (DL+GT) and the period T_{UL} of (UL+GT) are different from each other. The GTs are the same. In addition, the period T_{DL} and the period T_{UL} are alternately repeated with a fixed period. A sum of the period T_{DL} and the period T_{UL} illustrated in FIG. 4 is the same as a sum of the period T_{DL} and the period T_{UL} illustrated in FIGS. 2 and 3. In other words, although the sum of the period T_{DL} and the period T_{UL} is the same as that of the comparative example illustrated in FIG. 2, the payload length of the frame of the period T_{DL} is extended, and thus the transmission capacity in the period T_{DL} is improved from that of the comparative example illustrated in FIG. 2. In addition, although the sum of the period T_{DL} and the period T_{UL} is the same as that of the example illustrated in FIG. 3, the payload length of the frame in the period T_{DL} is extended from that of the example illustrated in FIG. 3, and thus the transmission capacity in the period T_{DL} is improved from that of the example illustrated in FIG. 3.

In this way, in the example illustrated in FIG. 4, by shortening the GTs of the DL and the UL and extending the payload length of the frame of only the DL, a surplus standby time at the end of the frame of the DL of the terminal station device 102 can be shortened. At the same time, the period T_{UL} is shortened in accordance with an increase in the period T_{DL}, and thus a standby time at the end of the frame of the UL can be shortened as well. In accordance with this, in each of the embodiments to be described below, the payload length of the frame of the DL is extended, and surplus standby times of the DL and the UL are shortened, whereby an effect of the transmission capacity being improved can be acquired.

Particularly, the example illustrated in FIG. 4 is highly effective for asymmetrical communication in which a transmission capacity of downlink is larger than a transmission capacity of uplink such as reading of a stream-based content and the like. Although FIG. 4 illustrates an example in which the frame configuration of the downlink is changed, the frame configuration of the uplink may be changed. Such a case, for example, can be highly effective for asymmetrical communication in which the transmission capacity of the uplink is larger than the transmission capacity of the downlink such as uploading of a captured image and the like.

### First Embodiment

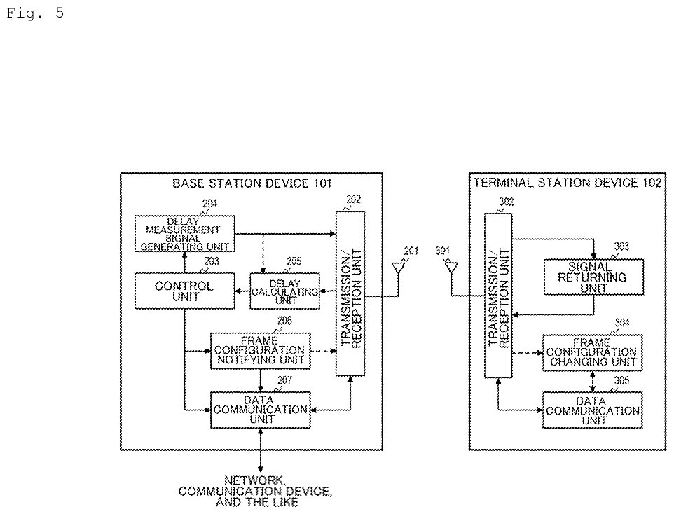

FIG. 5 is a diagram illustrating a configuration example of a base station device 101 and a terminal station device 102 according to a first embodiment.

### Configuration Example of Base Station Device 101

In FIG. 5, the base station device 101 includes an antenna 201, a transmission/reception unit 202, a control unit 203, a delay measurement signal generating unit 204, a delay calculating unit 205, a frame configuration notifying unit 206, and a data communication unit 207.

The antenna 201 converts a high frequency signal output by the transmission/reception unit 202 into an electromagnetic wave and transmits the electromagnetic wave to the terminal station device 102. To the contrary, the antenna 201 converts an electromagnetic wave transmitted by the terminal station device 102 into a high frequency signal and outputs the converted high frequency signal to the transmission/reception unit 202.

The transmission/reception unit 202 converts a transmission signal for the terminal station device 102 into a high frequency signal and outputs the converted high frequency signal to the antenna 201 and converts a high frequency signal input from the antenna 201 into a reception signal from the terminal station device 102.

The control unit 203 is configured using a computer operating in accordance with a program stored in advance and performs overall control of the base station device 101. For example, the control unit 203 performs a process of measuring a propagation delay between the base station device 101 and the terminal station device 102 and changing a frame configuration such that the surplus standby time described with reference to FIG. 3 or FIG. 4 is shortened (corresponding to a control process).

The delay measurement signal generating unit 204 generates a measurement signal determined in advance for measuring a propagation delay (referred to as a propagation delay measurement signal) in accordance with an instruction of the control unit 203 and outputs the generated propagation delay measurement signal to the transmission/reception unit 202. As the propagation delay measurement signal, for example, an M sequence sign or the like is used. Here, the propagation delay measurement signal may be transmitted before start of data communication or may be transmitted during data communication. In addition, a method for performing measurement as required during data communication by adding the propagation delay measurement signal to the start of the frame of communication data will be described below.

The delay calculating unit 205 calculates a propagation delay between the base station device 101 and the terminal station device 102 on the basis of information received from the terminal station device 102 (corresponding to a delay calculation process). Thereafter, the delay calculating unit 205 outputs the calculated propagation delay to the control unit 203. In the example illustrated in FIG. 5, the base station device 101 transmits a propagation delay measurement signal, and the terminal station device 102 returns and transmits the propagation delay measurement signal received from the base station device 101 to the base station device 101. The delay calculating unit 205 calculates a propagation delay by measuring a time until return of the propagation delay measurement signal after transmission thereof. For example, a time point at which the transmission/reception unit 202 has transmitted the M sequence sign and a time point at which the M sequence sign returned from the terminal station device 102 has been received are measured, and a difference between the reception time and the transmission time is calculated as a round-trip propagation delay. In addition, by taking a correlation with the same M sequence sign, the M sequence sign can be easily detected.

When the control unit 203 changes the frame configuration, the frame configuration notifying unit 206 performs a process of notifying the terminal station device 102 of information of the changed frame configuration. Here, as a method for notifying the terminal station device 102 of the frame configuration information, a method of storing frame configuration information in a header of communication data and transmitting the stored frame configuration information to the terminal station device 102 may be considered. Alternatively, a method of transmitting information of a frame configuration to the terminal station device 102 as independent control data before start of communication separately from communication data may be considered.

The data communication unit 207 converts communication data, for example, input from a network or a communication device connected to the outside into a transmission signal on the basis of the frame configuration output by the control unit 203 and transmits the converted transmission signal to the terminal station device 102. In addition, the data communication unit 207 converts a reception signal received from the terminal station device 102 into communication data and outputs the converted communication data to a network and a communication device connected to the outside. Here, as described above, in a case in which frame configuration information is transmitted to the terminal station device 102 with being stored in the header of communication data, the data communication unit 207 stores the frame configuration information output from the frame configuration notifying unit 206 in the header of the communication data.

In this way, the base station device 101 can shorten the surplus standby time described with reference to FIG. 3 or FIG. 4 by measuring a propagation delay for the terminal station device 102 and changing the frame configuration of communication data for the terminal station device 102.

### Configuration Example of Terminal Station Device 102

In FIG. 5, the terminal station device 102 includes an antenna 301, a transmission/reception unit 302, a signal returning unit 303, a frame configuration changing unit 304, and a data communication unit 305.

The antenna 301 converts a high frequency signal output by the transmission/reception unit 302 into an electromagnetic wave, transmits the electromagnetic wave to the base station device 101, converts an electromagnetic wave transmitted by the base station device 101 into a high frequency signal, and outputs the high frequency signal to the transmission/reception unit 302.

The transmission/reception unit 302 converts a transmission signal into a high frequency signal, outputs the high frequency signal to the antenna 301, and converts a high frequency signal input from the antenna 301 into a reception signal.

The signal returning unit 303 returns and outputs the propagation delay measurement signal received by the transmission/reception unit 302 to the transmission/reception unit 302.

The frame configuration changing unit 304 instructs the data communication unit 305 of a frame configuration used for transmission data and reception data on the basis of information of a frame configuration received from the base station device 101. Here, as described above, in a case in which the base station device 101 transmits frame configuration information with being stored in the header of communication data, the frame configuration changing unit 304 extracts the frame configuration information from reception data of the data communication unit 305 and instructs the data communication unit 305 of the frame configuration. Alternatively, in a case in which the base station device 101 transmits frame configuration information using control data other than communication data before start of communication or during communication, the frame configuration changing unit 304 receives the control data and instructs the data communication unit 305 of the frame configuration. In addition, the function of the frame configuration changing unit 304 may be included in the data communication unit 305.

The data communication unit 305 converts transmission data into a transmission signal on the basis of the frame configuration instructed from the frame configuration changing unit 304 and transmits the transmission signal from the transmission/reception unit 302 to the base station device 101. In addition, the data communication unit 305 converts a reception signal received by the transmission/reception unit 302 from the base station device 101 into reception data.

In this way, the terminal station device 102 returns back the propagation delay measurement signal received from the base station device 101 such that the base station device 101 can measure a round-trip propagation delay. Then, the terminal station device 102 is able to communicate with the base station device 101 for transmission data and reception data on the basis of the frame configuration notified from the base station device 101.

In addition, the function of the base station device 101 and the function of the terminal station device 102 may be reversed, a propagation delay measurement signal may be transmitted from the terminal station device 102 and returned from the base station device 101, and the terminal station device 102 may calculate a propagation delay.

### Example of Processing Sequence

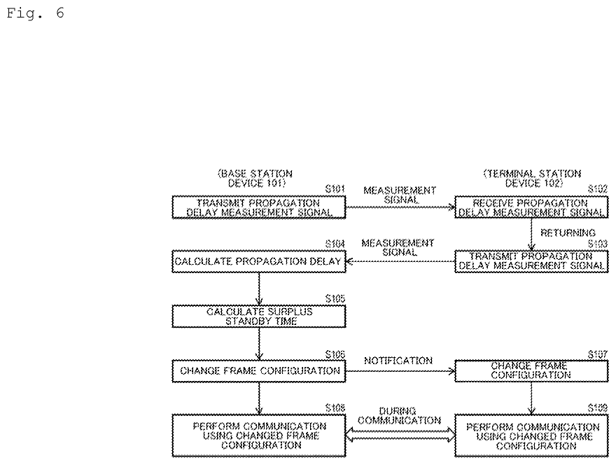

FIG. 6 illustrates an example of a processing sequence of the wireless communication system 100 according to the first embodiment. The process described with reference to FIG. 6 is performed by the base station device 101 and the terminal station device 102 described with reference to FIG. 5.

In Step S101, the delay measurement signal generating unit 204 of the base station device 101 generates a propagation delay measurement signal and transmits the generated propagation delay measurement signal from the transmission/reception unit 202 to the terminal station device 102.

In Step S102, the signal returning unit 303 of the terminal station device 102 receives the propagation delay measurement signal from the base station device 101.

In Step S103, the signal returning unit 303 of the terminal station device 102 returns and transmits the propagation delay measurement signal received from the base station device 101 to the base station device 101.

In Step S104, the delay calculating unit 205 of the base station device 101 receives the propagation delay measurement signal that is returned and transmitted from the terminal station device 102 and calculates a propagation delay.

In Step S105, the control unit 203 of the base station device 101 calculates a surplus standby time on the basis of the propagation delay acquired in Step S104. For example, in the case of FIG. 2, a time acquired by subtracting a margin from the standby time Tₛ is a surplus standby time.

In Step S106, the frame configuration notifying unit 206 of the base station device 101 changes the frame configuration on the basis of the surplus standby time calculated in Step S105 and transmits information of the changed frame configuration to the terminal station device 102. For example, in the case illustrated in FIG. 3 described above, the payload lengths of the frame of the DL and the frame of the UL of the terminal station device 102 are extended by lengths corresponding to two subframes. Alternatively, in the case of FIG. 4 described above, the payload length of the frame of the DL of the terminal station device 102(2) is extended by a length corresponding to four sub-frames.

In Step S107, the frame configuration changing unit 304 of the terminal station device 102 changes the frame configuration on the basis of information of the frame configuration notified from the base station device 101.

In Step S108, the data communication unit 207 of the base station device 101 communicates with the terminal station device 102 using the frame configuration changed in Step S106.

In Step S109, the data communication unit 305 of the terminal station device 102 communicates with the base station device 101 using the frame configuration changed in Step S107.

In this way, in the wireless communication system 100 according to the first embodiment, the base station device 101 measures a propagation delay for the terminal station device 102 and changes the frame configuration such that the surplus standby time as described with reference to FIG. 3 or FIG. 4 is shortened. In this way, the surplus standby time described with reference to FIG. 2 is shortened, and the payload length is extended, whereby an effect of the transmission capacity being improved can be acquired.

In addition, in FIGS. 5 and 6, although an example in which a round-trip propagation delay is measured on the base station device 101 side has been illustrated, by reversing the functions of the base station device 101 and the terminal station device 102, a propagation delay may be measured on the terminal station device 102 side. Alternatively, a propagation delay of each of the DL from the base station device 101 to the terminal station device 102 and the UL from the terminal station device 102 to the base station device 101 may be measured.

### Second Embodiment

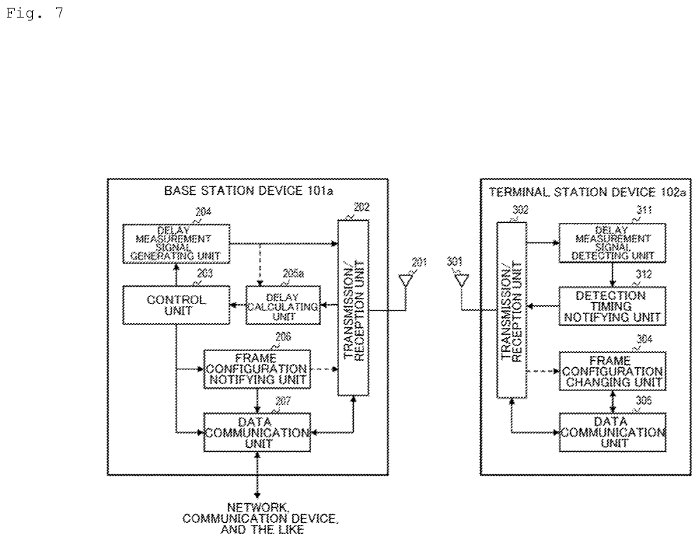

FIG. 7 is a diagram illustrating a configuration example of a base station device 101a and a terminal station device 102a according to a second embodiment. Here, the configuration of a wireless communication system 100a according to the second embodiment is the same as that of the wireless communication system 100 illustrated in FIG. 1, the base station device 101 illustrated in FIG. 1 can be substituted with the base station device 101a, and the terminal station device 102 can be substituted with the terminal station device 102a.

### Configuration Example of Base Station Device 101a

In FIG. 7, the base station device 101a includes an antenna 201, a transmission/reception unit 202, a control unit 203, a delay measurement signal generating unit 204, a delay calculating unit 205a, a frame configuration notifying unit 206, and a data communication unit 207.

Here, the configuration of the base station device 101a is basically the same as that of the base station device 101 according to the first embodiment, and thus the delay calculating unit 205a of which an operation is different will be described.

The delay calculating unit 205a receives information about a detection timing of a propagation delay measurement signal, which has been transmitted from the base station device 101a, in the terminal station device 102a from the terminal station device 102a. The information of a detection timing, for example, is information of a detection time of a propagation delay measurement signal, which has been transmitted from the base station device 101a, in the terminal station device 102a. In this case, it is assumed that time synchronization has been established between the base station device 101a and the terminal station device 102a using a global positioning system (GPS) or the like. On the other hand, the delay calculating unit 205a can acquire information of a transmission time of a propagation delay measurement signal from the delay measurement signal generating unit 204. Then, the delay calculating unit 205a calculates a difference between a reception time notified from the terminal station device 102a and a transmission time as a propagation delay (corresponding to a delay calculation process). The propagation delay calculated by the delay calculating unit 205a is output to the control unit 203. The control unit 203 changes the frame configuration on the basis of the propagation delay calculated by the delay calculating unit 205a.

A subsequent process is the same as that of the base station device 101 according to the first embodiment.

In this way, the base station device 101a measures a propagation delay for the terminal station device 102a and changes the frame configuration of communication data, thereby being able to shorten a surplus standby time described with reference to FIG. 3 or FIG. 4.

### Configuration Example of Terminal Station Device 102a

The terminal station device 102a includes an antenna 301, a transmission/reception unit 302, a frame configuration changing unit 304, a data communication unit 305, a delay measurement signal detecting unit 311, and a detection timing notifying unit 312.

Here, processes of the antenna 301, the transmission/reception unit 302, the frame configuration changing unit 304, and the data communication unit 305 are the same as those of the terminal station device 102 according to the first embodiment, and thus duplicate description will be omitted. The terminal station device 102a according to the second embodiment does not have the signal returning unit 303 of the terminal station device 102 according to the first embodiment but includes the delay measurement signal detecting unit 311 and the detection timing notifying unit 312.

The delay measurement signal detecting unit 311 detects a propagation delay measurement signal received by the transmission/reception unit 302 and outputs a detection timing (a detection time point) to the detection timing notifying unit 312.

The detection timing notifying unit 312 transmits information of the detection timing input from the delay measurement signal detecting unit 311 from the transmission/reception unit 302 to the base station device 101a. Here, the detection timing notifying unit 312 may transmit information of the detection timing to the base station device 101 with being stored in the header of communication data or may transmit information of the detection timing to the base station device 101 using control data other than the communication data.

Thus, the terminal station device 102a notifies the base station device 101a of the detection timing of the propagation delay measurement signal received from the base station device 101a such that the base station device 101a can measure a propagation delay. Then, the terminal station device 102a transmits/receives communication data to/from the base station device 101a on the basis of the frame configuration notified from the base station device 101a.

### Example of Processing Sequence

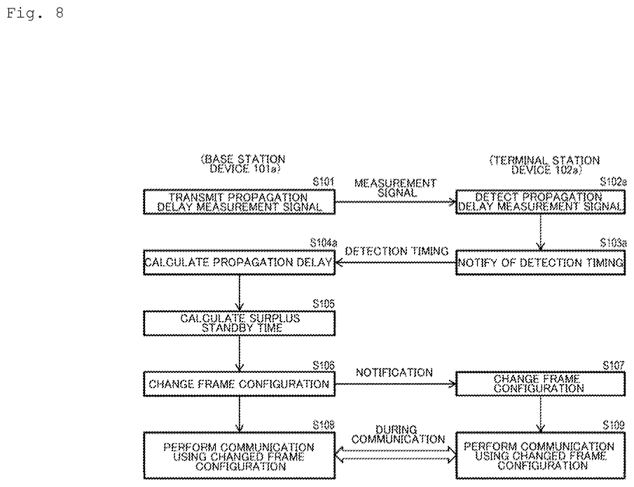

FIG. 8 is a diagram illustrating an example of a processing sequence of the wireless communication system 100a according to the second embodiment. The process described with reference to FIG. 8 is performed by the base station device 101a and the terminal station device 102a described with reference to FIG. 7.

In FIG. 8, processes of Step S101 and Steps S105 to S109 are the same as those of steps of the same reference signs described with reference to FIG. 6, and duplicate description will be omitted.

In Step S102a, the delay measurement signal detecting unit 311 of the terminal station device 102a detects a propagation delay measurement signal received from the base station device 101a and outputs a detection timing (a detection time point) to the detection timing notifying unit 312.

In Step S103a, the detection timing notifying unit 312 of the terminal station device 102a transmits information of the detection timing input from the delay measurement signal detecting unit 311 to the base station device 101a.

In Step S104a, the delay calculating unit 205a of the base station device 101a receives the information of the detection timing from a terminal station device 102a and calculates a propagation delay for each terminal station device 102a.

Thereafter, the processes of Step S105 to Step S109 are performed similarly to those illustrated in FIG. 6, and the base station device 101a changes the frame configuration on the basis of the calculated surplus standby time. Then, similar to the base station device 101 according to the first embodiment, the base station device 101a notifies the terminal station device 102a of the change of the frame configuration and performs communication with the terminal station device 102a using the changed frame configuration.

In this way, in the wireless communication system 100a according to the second embodiment, the base station device 101a measures a propagation delay for the terminal station device 102a and changes the frame configuration such that the surplus standby time as described with reference to FIG. 3 or FIG. 4 is shortened.

In accordance with this, the surplus standby time described with reference to FIG. 2 is shortened, and the payload length is extended, whereby an effect of the transmission capacity being improved can be acquired.

Here, in the second embodiment, although an example in which a propagation delay is calculated by transmitting a propagation delay measurement signal before start of data communication is illustrated, a propagation delay may be measured at any time during data communication by storing the propagation delay measurement signal in the header of a frame of the communication data.

In addition, in FIGS. 7 and 8, although an example in which a propagation delay of the DL is measured by transmitting a propagation delay measurement signal from the base station device 101a to the terminal station device 102a is illustrated, a propagation delay of a UL may be measured by transmitting a propagation delay measurement signal from the terminal station device 102a to the base station device 101a. Alternatively, propagation delays of both the DL and UL may be measured by transmitting propagation delay measurement signals from the base station device 101a and the terminal station device 102a.

### Third Embodiment

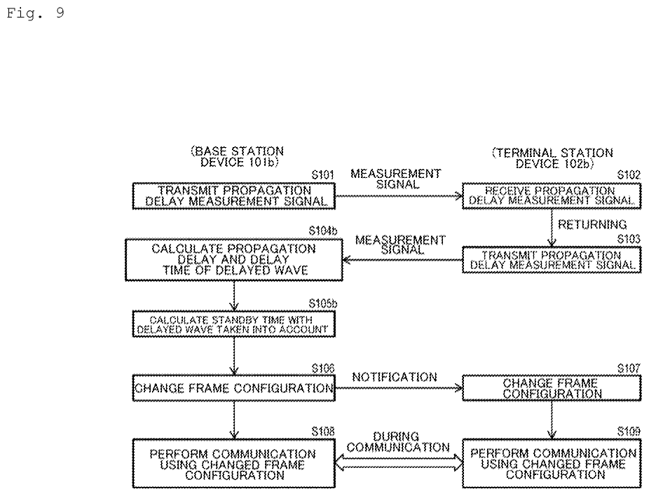

FIG. 9 is a diagram illustrating an example of a processing sequence of a wireless communication system 100b according to a third embodiment.

The wireless communication system 100b according to the third embodiment is the same as the wireless communication system 100 illustrated in FIG. 1, and the base station device 101 and the terminal station device 102 illustrated in FIG. 1 can be substituted with a base station device 101b and a terminal station device 102b.

Although the base station device 101b and the terminal station device 102b according to the third embodiment are composed of blocks that are basically the same as those according to the first embodiment illustrated in FIG. 5, operations of a delay calculating unit 205 and a control unit 203 are slightly different from those according to the first embodiment. In the third embodiment, the delay calculating unit 205 illustrated in FIG. 5 is substituted with a delay calculating unit 205b, and the control unit 203 is substituted with a control unit 203b in description.

In the third embodiment, a correlation of propagation delay measurement signals communicated between the base station device 101b and the terminal station device 102b is calculated, and not only a propagation delay but also a delay time of a delayed wave according to multiple paths and the like is calculated. Thereafter, the base station device 101b changes the frame configuration with the delay time of the delayed wave taken into account. More specifically, the base station device 101b changes the frame configuration such that there is no collision at the time of switching between a DL and a UL that are not ends of a frame of a direct wave but ends of a frame of a delayed wave.

In FIG. 9, processes of Step S101 to Step S103 and processes of Step S106 to Step S109 are the same as those of steps of the same reference signs described with reference to FIG. 6, and thus duplicate description will be omitted. Here, processes that are different from those illustrated in FIG. 6 will be described.

In Step S104b, the base station device 101b receives a propagation delay measurement signal that is returned and transmitted from a terminal station device 102b and calculates a propagation delay for each terminal station device 102b. In addition, the base station device 101b acquires a delay time of a delayed wave with which a propagation delay measurement signal received from the terminal station device 102b is received with a delay due to a multi-path and the like. The delay time can be acquired by taking a sliding correlation of propagation delay measurement signals received by the base station device 101b.

In Step S105b, the base station device 101b calculates a surplus standby time on the basis of the propagation delay and the delay time of the delayed wave acquired in Step S104b. For example, in the case illustrated in FIG. 2, although a surplus standby time is calculated from the end of a frame of a direct wave, in this embodiment, the base station device 101b calculates a surplus standby time from the end of a frame of the delayed wave. In addition, in a case in which there are a plurality of delayed waves, for example, the delayed wave may be limited to a first delayed wave assumed to have a relatively high effect or the like. Alternatively, by measuring levels of delayed waves, only delayed waves of which levels are equal to or larger than a threshold determined in advance may be considered.

Thereafter, processes of Step S106 to Step S109 are performed similarly to those illustrated in FIG. 6, and the base station device 101b changes the frame configuration on the basis of the calculated surplus standby time. Then, the base station device 101b notifies the terminal station device 102b of the change of the frame configuration and communicates with the terminal station device 102b using the changed frame configuration.

In this way, in the wireless communication system 100b according to the third embodiment, the base station device 101b calculates a surplus standby time by measuring a propagation delay for the terminal station device 102b and a delay time of the delayed wave and changes the frame configuration.

In accordance with this, the surplus standby time described with reference to FIG. 2 is shortened, and the payload length is extended, whereby an effect of the transmission capacity being improved can be acquired.

### Fourth Embodiment

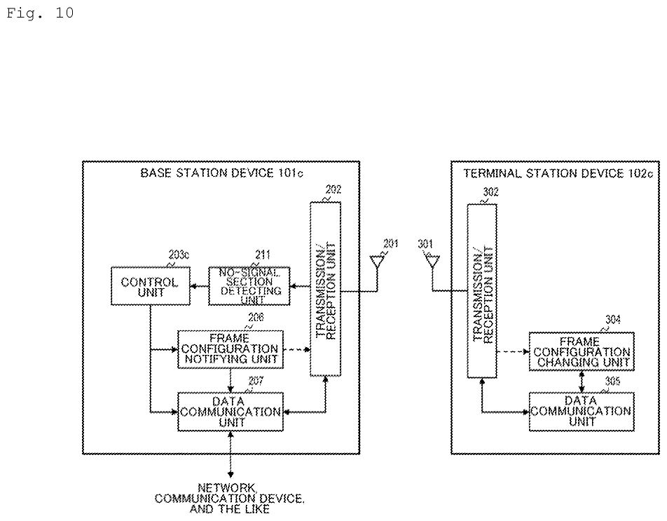

FIG. 10 illustrates a configuration example of a base station device 101c and a terminal station device 102c according to a fourth embodiment. Here, the configuration of a wireless communication system 100c according to the fourth embodiment is the same as that of the wireless communication system 100 illustrated in FIG. 1, and the base station device 101 and the terminal station device 102 illustrated in FIG. 1 can be respectively substituted with the base station device 101c and the terminal station device 102c.

### Configuration Example of Base Station Device 101c

In FIG. 10, the base station device 101c includes an antenna 201, a transmission/reception unit 202, a control unit 203c, a frame configuration notifying unit 206, a data communication unit 207, and a no-signal section detecting unit 211.

Here, in FIG. 10, each block having the same reference sign as that of the base station device 101 according to the first embodiment basically operates similarly, and thus different blocks will be described.

The no-signal section detecting unit 211 detects a no-signal section of a DL within a GT that is transmitted from the base station device 101c to the terminal station device 102c and a no-signal section of a UL within a GT that is transmitted from the terminal station device 102c to the base station device 101c (a detection process). Here, the no-signal section corresponds to a time Tₛ in the example illustrated in FIG. 2.

The control unit 203c calculates a surplus standby time between the base station device 101c and the terminal station device 102c on the basis of the no-signal sections detected by the no-signal section detecting unit 211. Not the entire no-signal section becomes a surplus standby time, but a time acquired by excluding a minimal margin required at the time of switching between the DL and the UL therefrom becomes a surplus standby time. Thereafter, the control unit 203c changes the frame configuration on the basis of the calculated surplus standby time.

A subsequent process is the same as that of the base station device 101 according to the first embodiment.

In this way, the base station device 101c changes the frame configuration of communication data on the basis of the no-signal section of the DL within the GT and the no-signal section of the UL within the GT, thereby being able to shorten the surplus standby time described with reference to FIG. 3 or 4. Particularly, in this embodiment, a propagation delay does not need to be measured by transmitting a propagation delay measurement signal, and no-signal sections during normal data communication are detected, whereby a surplus standby time can be shortened.

### Configuration Example of Terminal Station Device 102c

In FIG. 10, the terminal station device 102c includes an antenna 301, a transmission/reception unit 302, a frame configuration changing unit 304, and a data communication unit 305.

Here, as illustrated in FIG. 10, the terminal station device 102c does not have a particular block other than the blocks mounted in the terminal station device 102 according to the first embodiment. In other words, the terminal station device 102c performs data communication with the base station device 101c and, in a case in which a change of the frame configuration is notified from the base station device 101c, only changes the frame configuration of data communication.

In this way, the terminal station device 102c may only receive a notification of a change of the frame configuration from the base station device 101c and change the frame configuration of data communication and does not need to have a special function as in the other embodiments.

### Example of Processing Sequence

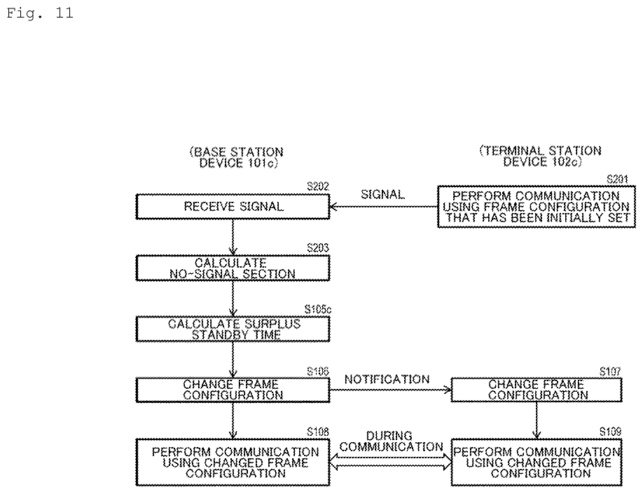

FIG. 11 illustrates an example of a processing sequence of the wireless communication system 100c according to the fourth embodiment. The process illustrated in FIG. 11 is performed by the base station device 101c and the terminal station device 102c described with reference to FIG. 10.

In FIG. 11, processes of Step S106 to Step S109 are the same as those of steps of the same reference signs described with reference to FIG. 6, and thus duplicate description will be omitted. Here, processes that are different from those illustrated in FIG. 6 will be described.

In Step S201, the data communication unit 305 of the terminal station device 102c performs data communication with the base station device 101c on the basis of a frame configuration that has been initialized in advance.

In Step S202, the transmission/reception unit 202 of the base station device 101c receives a signal of data communication from the terminal station device 102c.

In Step S203, the no-signal section detecting unit 211 of the base station device 101c detects no-signal sections of a frame of the data communication received from the terminal station device 102c.

In Step S105c, the control unit 203c of the base station device 101c calculates a surplus standby time on the basis of the no-signal sections.

Thereafter, processes of Step S106 to Step S109 are performed similarly to those illustrated in FIG. 6, and the base station device 101c changes the frame configuration on the basis of the calculated surplus standby time. Then, the base station device 101c notifies the terminal station device 102c of the change of the frame configuration and communicates with the terminal station device 102c using the changed frame configuration.

In this way, in the wireless communication system 100c according to the fourth embodiment, the base station device 101c calculates a surplus standby time by measuring a propagation delay for the terminal station device 102c and a delay time of a delayed wave and changes the frame configuration. In this way, the surplus standby time described with reference to FIG. 2 is shortened, and the payload length is extended, whereby an effect of the transmission capacity being improved can be acquired.

In FIGS. 10 and 11, although an example in which no-signal sections are detected on the base station device 101c side is illustrated, the functions of the base station device 101c and the terminal station device 102c may be reversed, and no-signal sections may be detected on the terminal station device 102c side. Alternatively, no-signal sections of each of a DL from the base station device 101c to the terminal station device 102c and a UL from the terminal station device 102c to the base station device 101c may be detected.

As described in each of the embodiments above, a wireless communication system, a base station device, and a wireless communication method according to the present invention change the frame configuration in a case in which a guard time for a propagation delay between a base station device and a terminal station device using time division multiplexing in a duplex operation system becomes excessively long, thereby being able to shorten a surplus standby time and improve transmission capacity.

In addition, the process performed by the base station device 101 (the base station device 101a, the base station device 101b, and the base station device 101c) according to each of the embodiments described with reference to FIGS. 5 to 11 can be realized also using a computer and a program. The program may be recorded on a recording medium such as a memory and mounted in the base station device 101 or may be provided through a network.

### REFERENCE SIGNS LIST

100, 100a, 100b, 100c Wireless communication system
101, 101a, 101b, 101c Base station device
102, 102a, 102b, 102c Terminal station device
201 Antenna
202 Transmission/reception unit
203, 203c Control unit
204 Delay measurement signal generating unit
205, 205a Delay calculating unit
206 Frame configuration notifying unit
207 Data communication unit
211 No-signal section detecting unit
301 Antenna
302 Transmission/reception unit
303 Signal returning unit
304 Frame configuration changing unit
305 Data communication unit
311 Delay measurement signal detecting unit
312 Detection timing notifying unit

1. A wireless communication system in which there is a propagation delay between a terminal station device and a base station device using time division multiplexing in a duplex operation system, wherein
at least one of the base station device or the terminal station device includes a delay calculating unit that calculates the propagation delay between the terminal station device and the base station device, and wherein
the base station device or the terminal station device includes a control unit that changes a frame configuration of at least one of an uplink frame or a downlink frame such that a standby time required for switching between the uplink frame from the terminal station device to the base station device and the downlink frame from the base station device to the terminal station device is shortened in accordance with the propagation delay calculated by the delay calculating unit.

2. (canceled)

3. The wireless communication system according to claim 1, wherein
the control unit extends a payload length of at least one of the uplink frame or the downlink frame.

4. The wireless communication system according to claim 3, wherein
the control unit changes at least one of a modulation system or an encoding system in accordance with an increase in a transmission capacity according to the extension of the payload length.

5. A base station device performing wireless communication with a terminal station device using time division multiplexing in a duplex operation system, the base station device comprising:
a delay calculating unit configured to calculate a propagation delay between the terminal station device and the base station device; and
a control unit configured to change a frame configuration of at least one of an uplink frame or a downlink frame such that a standby time required for switching between the uplink frame from the terminal station device to the base station device and the downlink frame from the base station device to the terminal station device is shortened in accordance with the propagation delay calculated by the delay calculating unit.

6. (canceled)

7. A wireless communication method in which there is a propagation delay between a terminal station device and a base station device using time division multiplexing in a duplex operation system, the wireless communication method comprising:
performing a delay calculating process of calculating the propagation delay between the terminal station device and the base station device by using at least one of the base station device or the terminal station device, and
performing a control process of changing a frame configuration of at least one of an uplink frame or a downlink frame such that a standby time required for switching between the uplink frame from the terminal station device to the base station device and the downlink frame from the base station device to the terminal station device is shortened in accordance with the propagation delay calculated in the delay calculating process by using the base station device or the terminal station device.

8. (canceled)
